(19) United States
(12) Patent Application Publication
(10) Pub. No.: US 2007/0220734 A1
(43) Pub. Date: Sep. 27, 2007

(54) HUB SEAL PRESS ASSEMBLY

(76) Inventor: Brendan Chambeyron, Wodonga (AU)

Correspondence Address: EDWIN D. SCHINDLER, FIVE HIRSCH AVENUE, P.O. BOX 966, CORAM, NY, 11727-0966, US

(21) Appl. No.: 11/533,420

(22) Filed: Sep. 20, 2006

(30) Foreign Application Priority Data
Sep. 20, 2005 (AU) 2005905174

(51) Int. Cl. B23P 19/02

(52) U.S. Cl. 29/525

(57) ABSTRACT

The present invention provides a hub seal press assembly including, a top plate and a base plate, a securing means, and a tightening member whereby the assembly is adapted to provide a means for securely and uniformly press-fitting a seal for a hub.

### TECHNICAL FIELD OF THE INVENTION

The invention relates to hub seals and in particular to a hub seal press assembly for trailer hubs which provides a means for securely and uniformly fitting a bearing seal into a hub.

Whilst the invention can also be applied to other hubs where it may be necessary to replace a bearing seal whilst traveling, for convenience sake it shall be described herein in terms of hub seals for marine, 4×4 and domestic trailers.

### BACKGROUND TO THE INVENTION

Trailers are a must for the transportation of boats, or other large items to and from various destinations, and like anything, they have components which must be maintained and looked after in order for the trailer to function safely and efficiently. In particular, the trailers bearings and seals should be consistently checked prior to making a trip in order to prevent burning a set of bearings and/or damage a wheel spindle, which can be frustrating and possibly disastrous occurrence when traveling along a highway a fair distance away from help.

It is advisable to carry spare bearings and seals in the case of such an emergency. The problem arises in attempting to replace the seal. It is extremely important to ensure that the seal is fitted correctly and securely as a faulty seal will eventually lead to the bearings being ruined, causing bearing failure within a short period of time. Generally, a person will press a seal into a hub using a hammer, or block in addition to a hammer, to provide a more uniform press.

The disadvantage with the current method is that the seal may not be securely fitted at all points along the perimeter of the seal, whereby uneven pressing of the seal may cause the seal to wobble during travel. There have been improved seals designed with a better lip to assist in providing an adequate seal. However, these seals still fail to provide a means of ensuring the secure and uniform press of the seal. Whilst a user has the option to purchase a new hub with the seal and bearing already press-fitted, this can be fairly costly and may not be readily available.

Accordingly, it is an object of the present invention to overcome or substantially ameliorate the disadvantages of the prior art by providing a portable hub seal press assembly for trailer hubs which provides a means for securely and uniformly fitting a bearing seal into a hub.

### SUMMARY OF THE INVENTION

The present invention provides a hub seal press assembly including:

a top plate and a base plate;

a securing means;

and a tightening member whereby the assembly is adapted to securely and uniformly press-fit a seal for a hub.

The hub is preferably adapted to be located between an upper surface of the base plate and lower surface of the top plate.

The top plate and the base plate preferably have provided an aperture which is adapted to receive the securing means therethough.

The securing means is preferably an elongated bolt which is adapted to receive each of the components of the seal press assembly thereover in order to provide a means for securing the components together. The elongated bolt preferably has a threaded portion which is adapted to be complimentary to, and engagable with, a threaded portion of the tightening member.

The invention preferably has a washer in the form of a flat, circular disc which is adapted to be positioned over the top plate of the hub seal press assembly to act as a buffer between the upper surface of the top plate and a contacting portion of the tightening member.

The tightening member preferably has at least one gripping portion to assist a user in gripping and rotating the tightening member in order to secure the components of the assembly together. The tightening member preferably has an annular portion having at least one thread provided on an inner wall which is adapted to be engageable with a threaded portion provided on the elongated bolt.

In order that the invention may be more readily understood we will describe by way of non-limiting example of a specific embodiment thereof.

### BRIEF DESCRIPTION OF THE DRAWING FIGURES

FIG. 1 shows a bottom perspective view of the hub seal press assembly in an assembled configuration according to a preferred embodiment of the invention.

FIG. 2 shows an exploded view of the hub seal press assembly according to a preferred embodiment of the invention.

FIG. 3 shows an exploded view of the hub seal press assembly according to a preferred embodiment of the invention being used to press a larger bearing seal of a wheel hub.

FIG. 4 shows an exploded view of the hub seal press assembly according to a preferred embodiment of the invention being used to press a smaller bearing seal of a wheel hub.

FIG. 5a shows a side cross-sectional view of the hub seal press assembly according to a preferred embodiment of the invention prior to the engagement of the seal and bearing of the hub positioned within the assembly.

FIG. 5b shows a side cross-sectional view of the hub seal press assembly according to a preferred embodiment of the invention following the engagement of the seal and bearing of the hub positioned within the assembly.

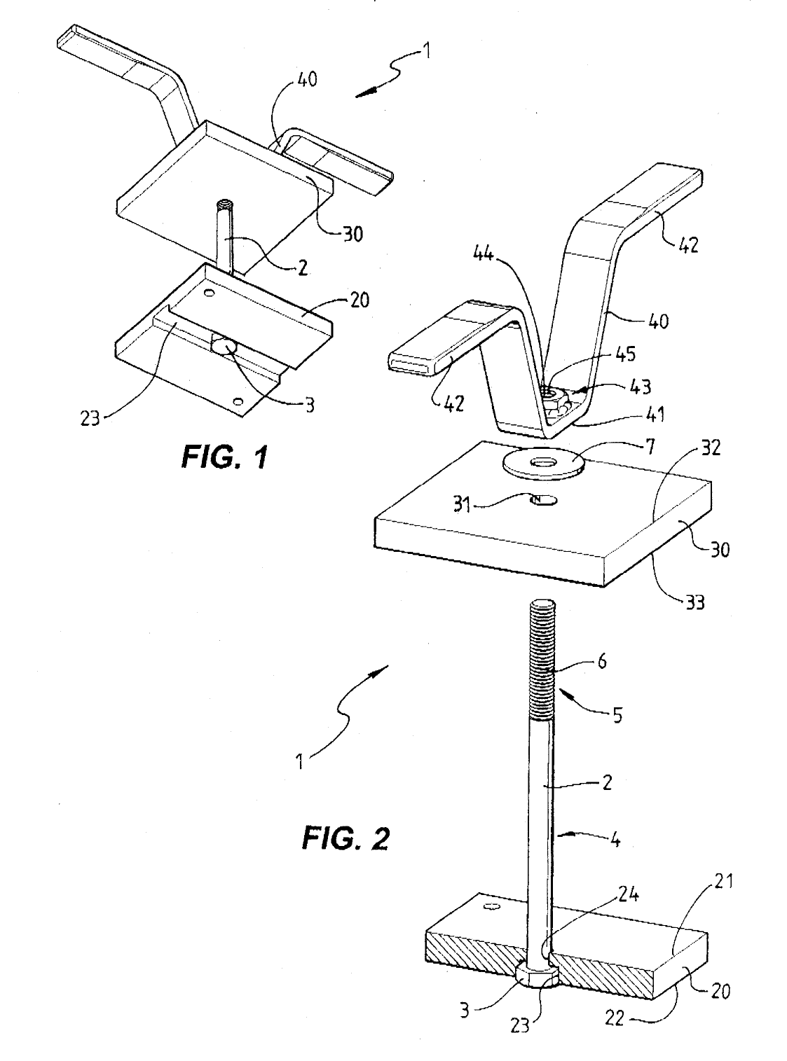

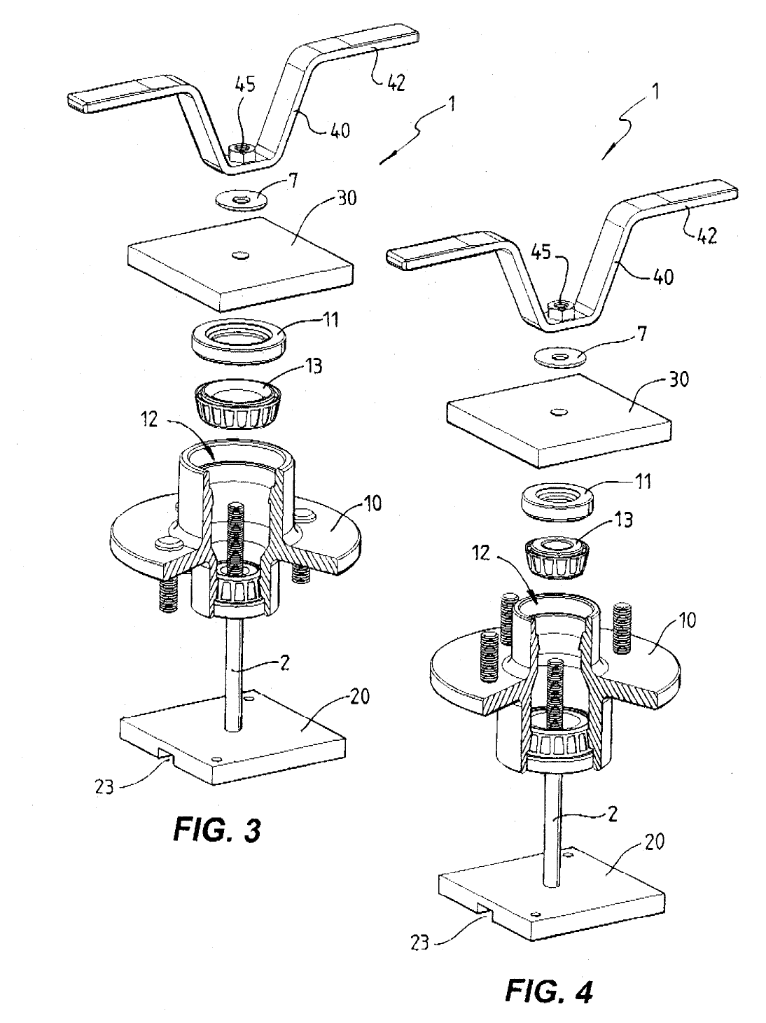

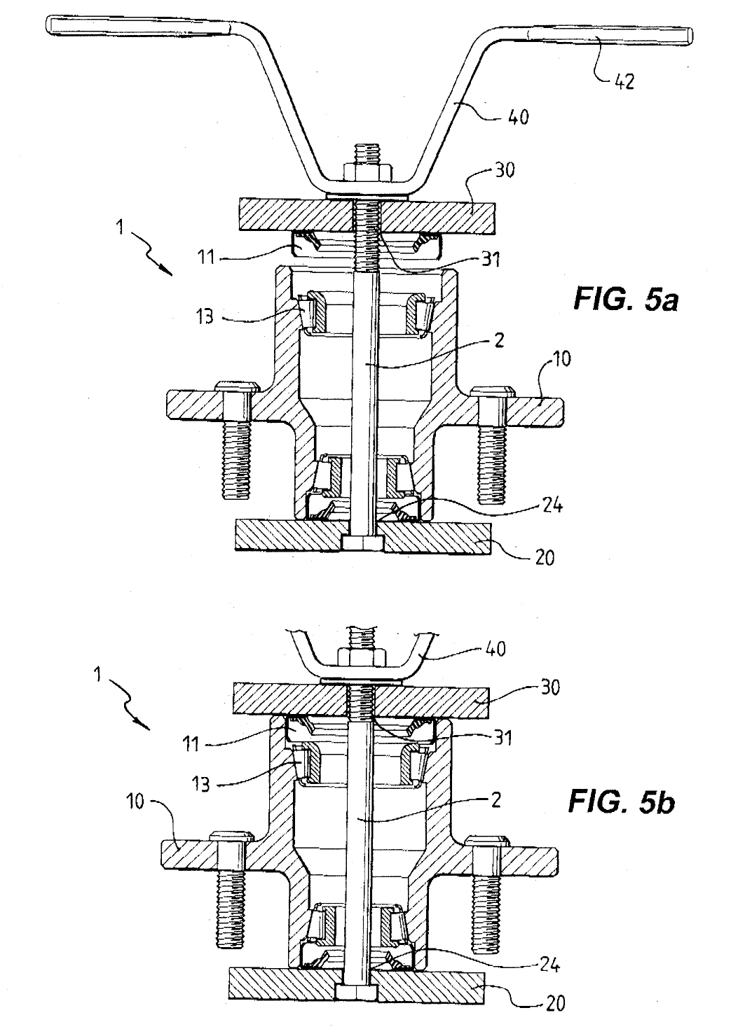

### DESCRIPTION OF A PREFERRED EMBODIMENT OF THE INVENTION

In this preferred embodiment, the invention provides a hub seal press assembly 1 which is adapted to securely and uniformly press-fit a seal 11 for a trailer hub 10. The hub seal press assembly 1 is preferably made of a die-cast metal material. However, any other suitable material may also be employed provided that the requirements of the invention are met. In a preferred embodiment of the invention, each of the components of the hub seal press assembly 1 are adapted to be interchangeable so that any one of the components may be replaced should they become damaged without needing to replace the whole device 1. The interchangeability of the components will also assist in enabling the device 1 to be disassembled for easy storage and portability.

The hub seal press assembly 1 has provided a base plate 20 having an upper surface 21 and a lower surface 22 which is adapted to form the base for the device 1. The base plate 20 is preferably square or rectangular in shape or any other suitable shape which allows even distribution of force to the hub 10 with dimensions sufficient to accommodate the central cylindrical portion of a wheel hub 10 placed on top of the upper surface 21 of the base plate 20. The lower surface 22 of the base plate 20 has provided a recess portion 23 which is adapted to be inwardly formed on the base plate 20. The recess portion 23 is preferably located centrally of the base plate 20 and is adapted to extend longitudinally or laterally across the entire length or width of the base plate 20. The width of the recess portion 23 is such that it is adapted to accommodate the top portion of a securing means therein. In an alternate embodiment of the invention, the recess portion 23 may be a centrally located recess portion 23 of any suitable shape which is adapted to receive a securing means therein. Provided in the centre of the base plate 20 and recess portion 23 is an aperture 24 which is adapted to receive a securing means 2 therethrough.

The securing means 2 of the hub press seal assembly is preferably an elongated bolt which is adapted to pass through the hub and both plates 20, 30 of the assembly and provide a means of enabling the components of the assembly 1 to be secured in place. The elongated bolt 2 is adapted to be inserted through the assembly 1 such that the bolt head 3 lies beneath, and is adapted to abut against, the lower surface 22 of the base plate 20, with the shank 4 of the bolt 2 extending perpendicularly upward relative to the base plate 20 of the assembly 1. The length of the elongated bolt 2 should be such that all components of the hub seal press assembly 1 can be received thereover. Provided at the end of the bolt 2 is a threaded portion 5 having at least one thread 6 provided thereon which is adapted to engage with a complimentary threaded portion (not shown) on a tightening member 40 and enable the hub seal press 1 to be tightened to complete the sealing process. In a preferred embodiment, the threads 6 are fine threads in order to increase the amount of torque that may be applied upon tightening of the bolt 2. In an alternate embodiment of the invention, it is envisaged that a screw or any other suitable securing means which can be passed through the entire assembly and tightened may also be adopted.

The hub seal press assembly 1 has provided a top plate 30. The top plate 30 is adapted to be located over the top of a hub 10 positioned within the assembly 1 and have the same and/or similar shape and dimensions as the base plate 20. The top plate 30 has provided an aperture 31 which is positioned centrally and/or in direct alignment with the aperture 24 provided on the base plate 20 of the device 1. The aperture 31 is preferably adapted to receive the elongated bolt 2 therethrough. The top plate 30 is adapted receive the shank 4 of the elongated bolt 2 therethrough and be located over a hub 10 such that, the hub 10 will be retained between the upper surface of 21 the base plate 20 and lower surface 33 of the top plate 30 of the hub seal press assembly 1.

The hub press seal assembly 1 preferably has provided a washer 7 which is adapted to be positioned over the top plate 30 of the hub seal press assembly 1 to act as a buffer between the upper surface 32 of the top plate 30 and a contacting portion 41 of the tightening member 40. The washer 7 is preferably made of a metallic or steel material. However, it is envisaged that any other suitable material may be utilised so long as the requirements of the invention are met. The washer 7 is preferably in the form of a flat circular disc. It is envisaged that the washer should have a suitable diameter such that it is able to withstand the pressure and/or tension applied by the tightening member 40.

The tightening member 40 of the hub seal press assembly 1 is adapted to secure all the components of the hub seal press assembly 1 and apply pressure and/or tension to the assembly 1 upon rotation of the member 40 in order to press a seal into place. The tightening member 40 preferably has an inverted triangular handle shape with two horizontal gripping portions 42 at the top of the tightening member 40 to allow a user to easily obtain a firm grip of the tightening member 40 so that, maximum power can be applied and a user's hand can be prevented from slipping and causing injury. Provided at the bottom contacting portion 41 of the tightening member 40 is an annular member 43 which is adapted to be integrally formed with, or welded to, the upper surface of the contacting portion 41 of the tightening member 40. The annular member 43 preferably has provided an aperture 44 which is adapted to receive the elongated bolt 2 therethrough. The aperture 44 preferably has at least one thread 45 provided along its inner wall which is adapted to receive and engage with the threaded portion 5 of the elongated bolt 2 such that, the tightening member 40 can receive the bolt 2 therethrough and secure the assembly 1 upon rotation of the tightening member 40.

In practice, in order to press fit a new seal 11 within a hub 10 the base plate 20 is placed with the recess portion 23 facing down and positioned over an inverted elongated bolt 2 such that the head 3 of the bolt 2 is below the base plate 20. A hub 10 is then positioned over the base plate 20 ensuring that the bolt 2 passes through the central aperture 12 of the hub 10. The bearing member 13 and seal member 11 are then positioned within the hub respectively. The top plate 30 can then be located over the top of the hub 10 and over the bearing 13 and seal 11 by positioning the aperture 31 of the top plate 30 over the shank 4 of the bolt 2 and allowing it to pass therethrough. A washer 7 can then be placed over the top plate 30 and the tightening member 40 engaged with the threaded portion 5 of the elongated bolt 2. Rotation of the tightening member 40 will then secure and apply pressure and/or tension to the assembly 1 to ensure that a uniform press-fit of the seal 11 is achieved.

In order to increase the torque applied to tighten the assembly 1 a horizontal lever device (not shown) may be used to enable a user to have a stronger grip and consequently apply more force. The lever may in the form of a rod like device which can be interweaved through the handle portion 42 of the tightening member 40 and used to tighten the member 40 by using at least one hand to push and/or pull the lever in opposite directions at each end.

While we have described herein a particular embodiment of hub seal press assembly 1, it is further envisaged that other embodiments of the invention could exhibit any number and combination of any one of the features previously described. However, it is to be understood that any variations and modifications can be made without departing from the spirit and scope thereof.

What is claimed is:

1. A hub seal press assembly, comprising:
a top plate and a base plate;
securing means; and,
a tightening member so that the assembly is adapted to securely and uniformly press-fit a seal for a hub.

2. A hub seal press assembly as claimed in claim 1, wherein a hub is adapted to be located between an upper surface of the base plate and lower surface of the top plate.

3. A hub seal press assembly as claimed in claim 1, wherein the top plate and the base plate have provided an aperture which is adapted to receive the securing means therethough.

4. A hub seal press assembly as claimed in claim 1, wherein a lower surface of the base plate has provided a recess portion which is adapted to be inwardly formed on said base plate.

5. A hub seal press assembly as claimed in claim 1, wherein the securing means is an elongated bolt.

6. A hub seal press assembly as claimed in claim 5, wherein the length of the elongated bolt is such that it is able to pass through all components of the hub seal press assembly.

7. A hub seal press assembly as claimed in claim 5, wherein the elongated bolt has a threaded portion which is adapted to be complimentary to, and engagable with, a threaded portion of the tightening member.

8. A hub seal press assembly as claimed in claim 1, further includes a washer.

9. A hub seal press assembly as claimed in claim 8, wherein the washer is in the form of a flat, circular disc which is adapted to be positioned over the top plate of the hub seal press assembly to act as a buffer between the upper surface of the top plate and a contacting portion of the tightening member.

10. A hub seal press assembly as claimed in claim 1, wherein the tightening member has at least one gripping portion to assist a user in gripping and rotating the tightening member in order to secure the components of the assembly together.

11. A hub seal press assembly as claimed in claim 1, wherein the tightening member has an annular portion having at least one thread provided on an inner wall which is adapted to be engageable with the threaded portion provided on the elongated bolt.
